(19) United States
(12) Patent Application Publication
(10) Pub. No.: US 2018/0229292 A1
(43) Pub. Date: Aug. 16, 2018

(54) Slip Techniques For Lost Casting Cores

(71) Applicant: Siemens Aktiengesellschaft, Muenchen (DE)

(72) Inventors: Hermann Boedinger, Muenchen (DE); Stefan Denneler, Muenchen (DE); Carsten Schuh, Baldham (DE); Matthias Uebler, Ursensollen (DE)

(73) Assignee: Siemens Aktiengesellschaft, Muenchen (DE)

(21) Appl. No.: 15/514,608

(22) PCT Filed: Sep. 23, 2015
(86) PCT No.: PCT/EP2015/071869

§ 371 Date: Mar. 27, 2017

(30) Foreign Application Priority Data
Sep. 29, 2014 (DE) 10 2014 219 652.3

(51) Int. Cl. B22C 1/22; B22C 1/10; C04B 26/14; C04B 35/111; C04B 35/486; C04B 35/626; C04B 35/63; C04B 35/634

(52) U.S. Cl. CPC B22C 1/226; B22C 1/2286; B22C 1/10; C04B 26/14; C04B 35/111; C04B 35/486; C04B 2235/6023; C04B 35/6316; C04B 35/63452; C04B 2235/3418; C04B 2235/5454; C04B 2235/5472; C04B 35/6264

(57) ABSTRACT

The present disclosure relates slip techniques for lost casting cores. The teachings thereof may be embodied in methods for producing a slip for use in casting, e.g., for production of complex metal blades in gas turbines. Some embodiments may include methods for producing a slip comprising: mixing at least one inorganic constituent with at least one first binder; and forming a slip with the mixture. The first binder may include a mixture of at least one epoxy resin and at least one sterically hindered amine as hardener.

### CROSS-REFERENCE TO RELATED APPLICATIONS

This application is a U.S. National Stage Application of International Application No. PCT/EP2015/071869 filed Sep. 23, 2015, which designates the United States of America, and claims priority to DE Application No. 10 2014 219 652.3 filed Sep. 29, 2014, the contents of which are hereby incorporated by reference in their entirety.

### TECHNICAL FIELD

The present disclosure relates slip techniques for lost casting cores. The teachings thereof may be embodied in methods for producing a slip for use in casting, e.g., for production of complex metal blades in gas turbines.

### BACKGROUND

In a precision metal casting process, as lost negative molds, ceramic casting cores serve for construction of complex positive geometries, particularly in the representation of microscale-sized surface structures which cannot be produced by conventional milling or machining forms because of undercuts, cavities or tooling-related resolution limits. The process may be of use in the more cost-effective production of complex metal blades in gas turbines and propulsion turbines.

To produce lost casting cores, the slip technique includes using a high-temperature-sinterable powder conglomerate composed of different kinds of inorganic constituents which is dispersed in a solvent with two types of binder which build on one another. This slip is poured into a casting mold for subsequent hardening. This casting mold bears the desired architectural and surface structuring which the ceramic casting core is intended to adopt in its later state. Through application of reduced pressure and vibration, the solvent, which serves primarily for reducing viscosity, is stripped off, and at the same time the filler powder fraction is sedimented off and compacted in accordance with the maximum packing density of the powder particle size distribution.

By warm or hot hardening at up to 160° C., the first binder or binder constituent undergoes polymerization, thus giving the resulting green compact the geometry which is to be fixed by sintering later on. Next, this green compact is freed from the casting mold and then sintered in a stepwise temperature profile to form the ceramic; at up to 300° C., the first binder constituent undergoes pyrolysis and is very largely expelled in the form of gaseous oxidation products.

To preserve the shape and architecture of the debinded green compact ahead of the final sintering at high temperatures, a second, high-temperature-resistant binder or binder constituent is commonly used which ensures the shape after debinding. At from about 250° C. to about 500° C., this constituent undergoes vitrification itself, giving off volatile constituents in so doing, to form an inorganic network which envelops and therefore fixes the fully debinded sintered ceramic powder. In a final temperature step, high-temperature sintering produces the ceramic which later serves for precision metal casting.

US 2011018944 A1 discloses an overall binder system comprising a combination of anhydrically thermosetting, cycloaliphatic epoxy resin and reactive, methylpolysiloxane-based silicone solid. With addition of dispersion additives, plastifiers (rubber), and solvents (methyl ethyl ketone, isopropyl alcohol or hexane), a slip formulation can be provided which has a high fraction of sintered ceramic powder and is fit for the casting of lost ceramic green cores. Cycloaliphatic epoxy resins are notable for particularly low dynamic viscosities, allowing required solvent contents to be lower. The hardener component of the epoxy resins is commonly an acid anhydride, of the methylhexahydrophthalic acid, methyltetrahydrophthalic acid or methylnadic acid type, for example. These mixtures constitute high-temperature systems which require an accelerator to initiate the polymerization and necessitate hardening temperatures of more than 130° C. over several hours. The reaction shrinkage is in the region of up to 5 vol %. the reactive silicone solid is a polycondensation-crosslinking alkoxyorganopolysiloxane which, under temperature exposure, undergoes pyrolysis to form amorphous quartz. The sintered ceramic powder is a multimodal, packing density-optimized mixture composed of amorphous fused silica, cristobalite, magnesium oxide, aluminum oxide, yttrium oxide, and zirconium oxide.

### SUMMARY

The teachings of the present disclosure may provide a slip, more particularly based on ceramic powder, which can be stabilized at particularly low temperatures. In some embodiments, a slip according to the teachings of the present disclosure may allow production of stable green compact stages at particularly low temperatures.

For example, some embodiments may include a method for producing a slip, wherein at least one inorganic constituent is mixed with at least one first binder and the first binder comprises a mixture of at least one epoxy resin and at least one hardener for the at least one epoxy resin. The may be embodied in a component produced by means of such a slip. The teachings may be applicable in particular to the more cost-effective production of complex metal blades in gas turbines and propulsion turbines of all kinds.

Some embodiments may include a method (S1, S1a, S1b, S1c) for producing a slip, wherein at least one inorganic constituent is mixed with at least one first binder and the first binder comprises a mixture of at least one epoxy resin and at least one sterically hindered amine as hardener.

In some embodiments, said at least one sterically hindered amine used comprises at least one amine organo-substituted in beta position.

In some embodiments, the at least one sterically hindered amine comprises at least one diamine.

In some embodiments, polyethylene glycol having repeating units of between 3 and 20 is admixed (Sib) to the hardener.

In some embodiments, the hardener comprises polyethermethyldiamine.

In some embodiments, the hardener comprises polyethermethyldiamine of type

H₂N—CH(—CH₃)⁻CH₂—[O—CH₂—CH(—CH₃)]ₓ⁻NH₂
where x is a repeating unit of 0 to 40, more particularly of 2 to 35, more particularly of 2 to 34.

In some embodiments, the at least one epoxy resin is or comprises a BADGE/BFDGE blend.

In some embodiments, the BADGE/BFDGE blend has been or is combined (Sib) with at least one epoxidic reactive diluent.

In some embodiments, the slip is admixed (Sic) with methyl ethyl ketone, acetone and/or isopropanol as solvent.

In some embodiments, the at least one inorganic constituent comprises (S1a) different fractions having particle size distributions bimodal or multimodal to one another.

In some embodiments, the slip comprises colloidally disperse, amorphous silicon dioxide nanoparticles, more particularly when a surface of the silicon dioxide nanoparticles has been covalently coated (Sic) with an epoxide-compatible adhesion promoter.

In some embodiments, the slip comprises (Sic) organic nanoparticles, more particularly epoxy resin-compatible polysiloxane nanoparticles.

In some embodiments, the at least one inorganic constituent comprises at least one ceramic powder.

Some embodiments may include a component produced by means of a slip, said slip having been produced by means of the method (S1, S1a, S1b, S1c) as described above.

### BRIEF DESCRIPTION OF THE DRAWINGS

The properties, features, and advantages of these teachings, as described above, and also the manner in which they are achieved, will become clearer and more readily understood in association with the following schematic description of a working example which is elucidated in more detail in association with a drawing. For greater of ease of comprehension, elements in the drawing that are the same or whose effect is the same may carry identical reference symbols.

FIG. 1 shows one possible course of the production of a ceramic casting core according to the teachings of the present disclosure.

### DETAILED DESCRIPTION

The teachings may enable a method for producing a slip, wherein at least one inorganic constituent is mixed with at least one first binder and the first binder comprises a mixture of at least one epoxy resin and at least on sterically hindered amine as hardener.

On the basis of the first binder thus constituted, the slip requires only very low (solidification) temperatures for its solidification and nevertheless features a processing time sufficiently long for producing a body by means of the slip. Slip processing times of several hours, for example, are achievable. The first binder does not require any accelerator substances to initiate hardening.

By means of this first binder, moreover, complete hardening can be achieved at this low temperature, enabling flexural strengths and breaking strengths to be provided that are acceptable for a further-processing operating chain. The first binder, furthermore, can be provided with a low viscosity, thereby facilitating the shaping of the slip in a casting mold. This first binder, furthermore, can be mixed with common solvents without undergoing decomposition, with mixing being possible in any proportion. The first binder performs addition-crosslinking hardening of the slip in a manner virtually free from reaction shrinkage, to form a stable molding.

It is possible to achieve solidification temperatures of not more than 70° C., more particularly of not more than 60° C., more particularly of not more than 50° C., more particularly of not more than 45° C., more particularly of not more than 40° C. This allows alternatingly applied wax templates to be used for multiwall geometries that are to be realized, and/or allows wax casting molds to be used. The property of low-temperature solidification, especially hardening, allows, in particular, the construction of multiwall casting cores through use of alternatingly applied template wax layers and slip layers. This method can only be used if the first binder undergoes polymerization to form the molding at below the wax melting point. The melting point of common waxes is typically 50° C. to 70° C. Binders presently in use, in contrast, require solidification temperatures beyond the wax melting point for complete hardening, meaning that a multilayer design is not possible with these conventional binders.

The slip, however, can also be poured into any casting molds, such as into silicone molds, for example, and so on. In that case, the low hardening temperature allows an energy saving, particularly simple production, and prevents softening or even damage to the casting mold.

The first binder may take the form in particular of a binder matrix comprising the at least one inorganic constituent (e.g., powder) as filler. An amine sterically hindered in beta position may be an amine which is sterically hindered in the beta position with respect to a terminal amine group.

The at least one epoxy resin may be an epoxy resin or a mixture of two or more epoxy resins. At least one epoxy resin may be a 1,2-epoxy resin. The methods may include mixing of the at least one epoxy resin and the at least one sterically hindered amine. Alternatively, a pre-prepared mixture may be used.

In some embodiments said at least one sterically hindered amine comprises at least one amine organo-substituted in beta position. Such amines permit the above advantages to be achieved at low production cost and complexity, and are inexpensive. Through steric hindrance by means of organic groups such as methyl, ethyl, propyl and/or higher in beta position to the terminal amine, the reactivity of the terminal amine (amino) group can be reduced significantly in relation r to 1,2-epoxide reactants, hence allowing the processing time to be extended. A diamine sterically hindered by a methyl group, for example, is known under the trade name of “Jeffamine D-230” from the company “Huntsman Corporation”.

In contrast, amines without steric hindrance, in combination with epoxy resins, have a pot life at room temperature of just a few minutes, a reason for their use as two-part instant adhesives. Given that the filling, degassing, and vibrating of the filled casting mold for the processing of slip formulations takes about an hour, however, these unhindered resin species may be unfit for the purpose stated. Conversely, amines organo-substituted in beta position exhibit a significantly extended gel time in reaction with 1,2-oxirane units, such as, for example, bisphenol A diglycidyl ether resins (also referred to hereinafter as “BADGE”) or bisphenol F diglycidyl ether resins (also referred to hereinafter as “BADGE”).

Generally, the epoxy resin(s) used may comprise, for example, BADGE, BFDGE and/or cycloaliphatic epoxy resins having terminal 1,2-oxirane units, which are available, for example, from Huntsman under the tradenames “Araldite PY 306”, “CY 184” or “CY 192” or from the company “Momentive” under the tradenames “EPR158” or “EPR162”.

In some embodiments, the at least one sterically hindered amine comprises at least one sterically hindered diamine. It has emerged, indeed, that the use of diamines has effects including that of furnishing particularly dynamic viscosity values.

Because short amines (including short diamines) in combination with 1,2-epoxy resins lead to relatively brittle molding materials, on account of the high network density developed, a certain flexibility in the high-polymeric network may prevent crack initiation and crack propagation. Polyethylene glycols having repeating units in the range from 3 to 20 can be used as additives for this purpose in epoxy resins. If segments with this kind of flexibility are present as spacers in the sterically hindered diamine, polyglycols with terminal hydroxyl groups may act catalytically on the initiation of polymerization. In one embodiment, the hardener or the first binder is additionally admixed with polyethylene glycol having repeating units of between 3 and 20, more particularly having repeating units of between 3 and 20.

Some structures of the hardener, more particularly hardener molecule, comprise polyethermethyldiamines. The hardener or the first binder may comprise polyethermethyldiamine(s) (also referred to hereinafter as “PEMDA”).

In some embodiments, he hardener comprises polyethermethyldiamine(s) of type

H₂N—CH(—CH₃)—CH₂—[O—CH₂—CH(—CH₃)]ₓ—NH₂ (I)

where x is a repeating unit of 0 to 40, more particularly of 2 to 35, more particularly of 2 to 34. The dynamic viscosities of the compound(s) (I) having a repeating unit number x of 2 to 3 is approximately 10 mPas at 25° C. and is consequently approximately ten times lower than the dynamic viscosity of the highly mobile methyltetrahydrophthalic anhydride that is often used in thermosetting systems.

Since cycloaliphatic epoxy resins having very low viscosities often conform to the type of 3,4-epoxycyclohexylmethyl 3′,4′-epoxycyclohexanecarboxylate (“cycloaliphatic”), hardening may be carried out with the hardener (I), resulting in an extremely highly mobile binder matrix. The reactivity of the hindered polyethermethyldiamines relative to the 3,4-epoxycyclohexylmethyl 3′,4′-epoxycyclohexanecarboxylate, however, is so low that no gelling and/or reaction occurs even at elevated temperatures and on addition of accelerator in high percentage concentrations.

Bisphenol A diglycidyl ether resins (BADGE) or bisphenol F diglycidyl ether resins (BFDGE) exhibit dynamic viscosities in the 4000-12 000 mPas range at room temperature, and so mixtures of this kind are—unfortunately—relatively viscous. Distilled bisphenol F diglycidyl ether resins having dynamic viscosities in the 1200-1400 mPas range at room temperature are available commercially, but they are expensive and tend toward rapid crystallization; for formulation, this makes it necessary to carry out preheating or even continual hot holding, which may lead in turn to curtailment of pot lives, possibly, on mixing with the sterically hindered amines, especially polyethermethyldiamines (PEMDA). In some embodiments, consequently, the at least one epoxy resin used comprises at least one bisphenol A/bisphenol F diglycidyl ether blend (“BADGE/BFDGE”), and/or the at least one epoxy resin comprises at least one BADGE/BFDGE blend which no longer exhibits any tendency toward crystallization. The BADGE/BFDGE blend can be mixed as part of the method or provided as a preprepared blend.

In some embodiments, the BADGE/BFDGE blend or a mixture of BADGE/BFDGE and PEMDA may be combined with at least one reactive diluent (also referred to hereinafter as “RD”), more particularly with at least one epoxidic reactive diluent. The effect of the at least one reactive diluent may improve the dynamic viscosity of the first binder. Preformulated products of the BADGE/BFDGE blends (e.g., BADGE/BFDGE or BADGE/BFDGE/RD) are available, for example, from Huntsman Corporation under the tradename “Araldite LY 1564”, Araldite LY 1568″, “Araldite GY 793” or “Araldite GY 794”. Alternatively, the BADGE/BFDGE blend may not be mixed together until during execution of the methods taught herein.

In some embodiments, the epoxidic reactive diluent is a mono- and/or difunctional epoxidic reactive diluent. Examples of reactive diluents which may be used are 1,4-butanediol diglycidyl ether, 1,6-hexanediol diglycidyl ether, neopentyl diglycidyl ether, cresyl glycide or the like. Mixtures of this kind (BADGE/BFDGE/RD) or (BADGE/BFDGE/PEMDA/RD) in particular exhibit dynamic viscosities which are comparable with that of the extremely high-priced cycloaliphatic 3,4-epoxycyclohexylmethyl 3′, 4′-epoxycyclohexanecarboxylate, but may exhibit polymerization with the sterically hindered amines, especially polyethermethyldiamines (PEMDA). The prepared formulations of mono- and difunctional reactive diluents in bisphenol A/bisphenol F diglycidyl ether mixtures with polyethermethyldiamines as hardener, in particular, possess a lower mixing viscosity than, for example, a combination of cycloaliphatic epoxy resin and methylnadic acid (“MNA”) at relevant casting shear rates.

The gelling times of the base component mixtures were tested using a gel time meter on filler-free 12 g materials at 23° C. A BADGE/PEMDA (x=2-3) matrix (Huntsman CY 228) may gel after about 9.5 h; a BFGDE/PEMDA (x=2-3) formulation with distilled bisphenol F diglycidyl ether (Hexion EPR 0158) may gel after approximately 16.5 h. The shortening in the case of the bisphenol A diglycidyl ester is attributable to the presence of the hydroxyl-containing repeating unit.

The mixtures comprising PEMDA hardeners, e.g., in accordance with formulation (I), are soluble without decomposition in the solvents methyl ethyl ketone, acetone, and isopropyl alcohol. In some embodiments, therefore, the slip comprises and/or is admixed with methyl ethyl ketone, acetone and/or isopropanol as solvent.

A further component of the binder matrix may comprise a condensation-crosslinking silicone solid, which likewise dissolves very well to well in the above solvents, relatively low solvent contents are required in order to set optimum flowabilities with dissolution of all binder constituents.

The at least one inorganic constituent may comprise at least one powder or an inorganic powder constituent. The at least one inorganic constituent may comprise at least one ceramic powder, more particularly sinterable ceramic powder, e.g., magnesium oxide, aluminum oxide, yttrium oxide, and/or zirconium oxide. In addition to the at least one ceramic powder, the inorganic constituent may comprise at least one inorganic, nonceramic powder, e.g., amorphous fused silica and/or cristobalite. A green compact or green body can be formed from an at least partly ceramic powder. The at least one powder may be in dispersion in the first binder.

A green compact density is determined substantially by a maximum packing density of the ceramic powder, more particularly of the dispersed ceramic powder. Given that, some embodiments may include a maximum theoretical packing coefficient as high as possible. Through adjustment of multimodalities within the filler fraction, it is a known possibility for the packing density to be increased. For instance, the packing of a monodisperse powder with a Gaussian distribution around a defined particle diameter is approximately 64 vol %. By means of (“bimodal”) addition of at least one further powder fraction, whose particle diameter is selected such that the interspaces or interstices of the relatively coarse powder particles are partially filled by the smaller powder particles, packing densities of up to 80 vol % result. A trimodal powder mixture allows even higher packing densities of up to 90 vol %. Multimodal filler fractions are often employed as sintering powders, since in this way, contacts between adjacent powder particles are generated sufficiently, leading to a sintered ceramic of particularly low pore content. In some embodiments, the at least one inorganic constituent comprises different fractions, more particularly powder fractions, more particularly ceramic powder fractions, having particle size distributions that are multimodal (bimodal, trimodal, etc.) to one another.

Increasing the maximum packing coefficient of the slip or of a body (more particularly a green body) produced therefrom can be increased by incorporation or introduction of nanoparticles, more particularly inorganic nanoparticles, into the slip or as a constituent of the slip. The nanoparticles may insert themselves into the interspaces or interstices even of multimodal powder mixtures. Since inorganic nanoparticles are often present in powder form, with a tendency toward agglomeration and aggregation, and since they are difficult to separate mechanically, dispersion into the first binder in this way may be difficult to achieve and result in sharp increases in viscosity. Some embodiments may include colloidally disperse, inorganic, amorphous silicon dioxide nanoparticles in solvents. In some embodiments, the slip, more particularly at least one inorganic constituent thereof, comprises colloidally disperse, amorphous silicon dioxide nanoparticles, more particularly in the form of a colloid solution.

A colloid solution of this kind is particularly stable with respect to agglomeration if the surface of the silicon particles is covalently covered or “coated” with an epoxide-compatible adhesion promoter. In this way, even after stripping of the solvent, there is no coagulation or aggregation of the nanoscale filler particles.

In some embodiments, the slip comprises organic nanoparticles. These nanoparticles may serve as plastifying agents. Like the inorganic nanoparticles, the organic nanoparticles may migrate into the free interspaces or interstices of the powder or powder filler, and act as effective flexibilizers during the formation of the brittle, high-polymeric epoxide binder network. The organic nanoparticles may comprise epoxy resin-compatible polysiloxane, since this polysiloxane itself undergoes vitrification to form amorphous silicon dioxide in a sintering step, and so likewise leads to an increase in green compact density.

In some embodiments, these organic and/or inorganic nanoparticles are present in dispersion in epoxy resin or in an epoxy resin matrix and in that form can be supplied particularly easily to the slip.

In some embodiments, the slip comprises at least one second binder, which has a higher temperature stability than the first binder. As a result, ceramic casting cores can be produced which may require higher temperatures. It is possible in this way for a shape of the molding produced from the slip, from which the first binder has already been expelled, to be retained even at high temperatures, such as during a sintering procedure, for example.

The first binder and the second binder may also be understood as first and second binder constituents of a binder, respectively. The first binder may provide the fundamental geometry or shape to a molding produced by the hardening of the binder in a casting mold. The molding may take the form, for example, of a ceramic powder-based green compact for fixing by sintering later on.

This hardened molding may subsequently be freed from the casting mold and then solidified in a stepwise temperature profile. Accordingly, a green compact may be sintered to form a ceramic body. Within the temperature profile, the first binder or binder constituent may be removed, by pyrolysis, for example (e.g., from about 300° C.), and then largely expelled in the form of gaseous oxidation products. So that the molding, more particularly green compact, freed from the first binder retains its shape ahead of the subsequent sintering at high temperatures, the second, high-temperature-resistant binder or binder constituent is used, and ensures the shape of the molding after debinding to remove the first binder. The second binder may undergo vitrification, in particular, at above 250° C. to 500° C., possibly giving off volatile constituents as it does so. As a result of the vitrification, the second binder may itself be reformed into an inorganic network which surrounds the fully debindered sintered powder, more particularly sintered ceramic powder, and hence also fixes it at high temperatures.

For reliable fixing of the inorganic constituents, more particularly ceramic powder particles, at high temperatures, in some embodiments, the second binder comprises a condensation-crosslinking silicone solid. Such a solid may be highly soluble in methyl ethyl ketone, acetone, and/or isopropyl alcohol, and so relatively low solvent contents can be implemented for the adjustment of optimum flowabilities with dissolution of all binder constituents. This as well is an advantage of using the solvents methyl ethyl ketone, acetone and/or isopropyl alcohol.

Some embodiments may include components such as a casting mold, more particularly a casting core, for a metallic cast component, such as for a metal blade in gas turbines and propulsion turbines, for example.

By using bisphenol A diglycidyl ether, bisphenol F diglycidyl ether, monofunctional and/or more highly functional, epoxide-based reactive diluents with beta-alkyl group-substituted polyethermonoamines and/or polyetherdiamines, it is possible to produce low-temperature-hardening formulations whose viscosity is comparable with or lower than that of the most highly mobile thermosetting cycloaliphatic epoxy resin/acid anhydride binder systems. These mixtures have processing times of several hours and do not require accelerator substances for hardener initiation. These resin mixtures can be mixed in any proportion with solvents, without decomposition, and undergo addition-crosslinking hardening with virtually no reaction shrinkage to form stable molding materials.

These base resin mixtures can be enhanced with sintered ceramic powder to constitute low-temperature slip systems for casting core applications. As a result of the low hardening temperature, the thermal expansion is particularly low, allowing increased dimensional accuracy in the design of the sintered ceramic dimensions. Nanoparticle-enhanced masterbatches with inorganic silicon dioxide particles, carrying epoxy resin-compatible adhesion promoter molecules on the nanoparticle surface, may function, moreover, as solvent supplier and simultaneously as a particle feedstock, thus leading to increased green core densities. Organic nanoparticle batches with polysiloxane particles constitute effective plastifiers, which undergo inorganic vitrification even at elevated temperatures.

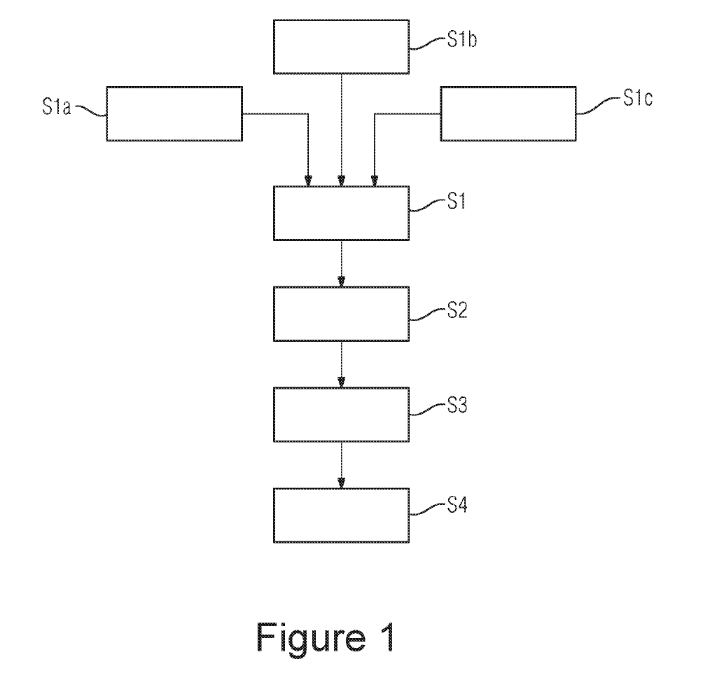

FIG. 1 shows one possible course of the production of a ceramic casting core according to the teachings of the present disclosure. In a first step S1, a slip based on ceramic powder is produced.

In a first substep S1a, a powder mixture which has a multimodal size distribution and is composed of one or more ceramic powders is added—for example, it comprises magnesium oxide, aluminum oxide, yttrium oxide, and zirconium oxide. The multimodal powder mixture may more particularly be a powder mixture with a bimodal or trimodal size distribution.

In a second substep S1b, a first binder is added, specifically by bringing together a blend of BADGE and BFDGE with PEMDA of formulation (I) having a repeating unit of 2 to 34 as hardener, with the further addition of a mono- or difunctional, epoxidic reactive diluent RD.

In a third substep S1c, solvent is added in the form of methyl ethyl ketone, acetone and/or isopropanol. The solvent may be admixed with silicon dioxide nanoparticles which are colloidally disperse, amorphous, and coated covalently with an epoxide-compatible adhesion promoter. Epoxy resin-compatible polysiloxane nanoparticles are admixed as second binder to the solvent as well.

By combining the starting materials from substeps S1a, S1b, and S1c (e.g., the multimodal size-distributed ceramic powder, the (BADGE/BFDGE/PEMDA/RD) mixture, and the nanoparticle-admixed solvent), the slip is produced. This combining may comprise a dispersing operation. Combining initiates a hardening process of the first binder and hence also a solidification of the slip.

The starting materials provided in substeps S1a, S1b and S1c may in principle be combined in any order.

In a subsequent shaping step S2, the slip is shaped or processed in its still-viscous state, being processed layer by layer in alternation with template wax layers to form a green body.

In a subsequent hardening step S3, the first binder hardens with retention of the template wax layers, e.g., at a temperature of not more than 50° C., more particularly of not more than 40° C. At the end of the hardening step S3, the first binder may be fully hardened, and the shaped slip includes a green body with a geometry to be fixed by sintering later on. The green body is still coherent with the wax.

In a temperature treatment step S4, the green body is subjected to a heat treatment, the solvent having been stripped off beforehand by application of reduced pressure and/or vibration. In the course of the temperature treatment step S4, the wax first becomes fluid and runs off from the green body. The green compact is therefore freed from its wax “casting mold”.

At temperatures up to about 300° C., the first binder may be pyrolyzed and is very largely expelled in the form of gaseous oxidation products. Above about 250° C. to about 500° C., the second binder undergoes vitrification, giving off volatile constituents as it does so, to form an inorganic network, which surrounds and thus fixes the sinterable ceramic powder fully debindered to remove the first binder.

In a last component temperature step, the ceramic powder particles are sintered by high-temperature sintering, of between 850° C. and 1300° C., for example, more particularly to about 1200° C., to form a sintered ceramic body. The sintered ceramic body may, for example, serve as a casting core or as a casting mold for subsequent precision metal casting.

Despite the teachings having been described and illustrated in more detail by the working example shown, the disclosure is not confined to this example, and other variations can be derived from it by the skilled person without departing from the scope thereof.

Generally speaking, “a”, “one”, etc., may be understood as a singular or a plural, more particularly in the sense of “at least one” or “one or more”, etc., unless such possibility is explicitly excluded, by the expression “precisely one”, etc., for example.

Moreover, a numerical figure may encompass precisely the number stated and also a customary tolerance range, unless that possibility is explicitly excluded.

What is claimed is:

1. A method for producing a slip, the method comprising:
mixing at least one inorganic constituent with at least one first binder; and
forming a slip with the mixture;
wherein the first binder comprises a mixture of at least one epoxy resin and at least one sterically hindered amine as hardener.

2. The method as claimed in claim 1, wherein said at least one sterically hindered amine comprises at least one amine organo-substituted in beta position.

3. The method as claimed in claim 1, wherein the at least one sterically hindered amine comprises at least one diamine.

4. The method as claimed in claim 1, wherein the hardener comprises polyethylene glycol having repeating units of between 3 and 20.

5. The method as claimed in claim 1, wherein the hardener comprises polyethermethyldiamine.

6. The method as claimed in claim 5, wherein the hardener comprises polyethermethyldiamine of type:
H₂N—CH(—CH₃)—CH₂—[O—CH₂—CH(—CH₃)]ₓ—NH₂
where x is a repeating unit of 0 to 40.

7. The method as claimed in claim 1, wherein the at least one epoxy resin comprises a BADGE/BFDGE blend.

8. The method as claimed in claim 7, wherein the at least one epoxy resin comprises at least one epoxidic reactive diluent.

9. The method as claimed in claim 1, further comprising admixing methyl ethyl ketone, acetone, and/or isopropanol as solvent.

10. The method as claimed in claim 1, wherein the at least one inorganic constituent comprises more than one fractions having particle size distributions bimodal or multimodal to one another.

11. The method as claimed in claim 1, wherein the mixture comprises colloidally disperse, amorphous silicon dioxide nanoparticles.

12. The method as claimed in claim 1, wherein the mixture comprises organic nanoparticles.

13. The method as claimed in claim 1, wherein the at least one inorganic constituent comprises ceramic powder.

14. (canceled)

15. The method as claimed in claim 1, wherein:
the mixture comprises colloidally disperse, amorphous silicon dioxide nanoparticles; and
a surface of the silicon dioxide nanoparticles has been covalently coated with an epoxide-compatible adhesion promoter.

16. The method as claimed in claim 1, wherein the mixture comprises epoxy resin-compatible polysiloxane nanoparticles.
